(19) United States
(12) Patent Application Publication
(10) Pub. No.: US 2022/0415180 A1
(43) Pub. Date: Dec. 29, 2022

(54) OPERATION OF A VEHICLE PLATOON WITH A PLURALITY OF MOTOR VEHICLES

(71) Applicant: Ford Global Technologies, LLC, Dearborn, MI (US)

(72) Inventors: Peter W.A. Zegelaar, Heerlen (NL); Alexander Katriniok, Aachen/NRW (DE); Martin Sommer, Aachen/NRW (DE)

(73) Assignee: Ford Global Technologies, LLC, Dearborn, MI (US)

(21) Appl. No.: 17/746,353

(22) Filed: May 17, 2022

(30) Foreign Application Priority Data
Jun. 25, 2021 (DE) 102021116468.0

(51) Int. Cl. G08G 1/00; B60W 30/165; B60W 30/14; B60W 10/18; G05D 1/02

(52) U.S. Cl. CPC G08G 1/22; B60W 30/165; B60W 30/143; B60W 10/18; G05D 1/0295; G05D 1/0293; B60W 2556/65; G05D 2201/0213

(57) ABSTRACT

A method for operating a vehicle platoon with a plurality of motor vehicles includes recording of operating data of each motor vehicle of the vehicle platoon, transmitting the recorded operating data of at least one following motor vehicle of the vehicle platoon to the first motor vehicle of the vehicle platoon, evaluating the operating data to determine a control signal data set for controlling a component of each of the motor vehicles of the vehicle platoon, transmitting the respective control signal data sets to at least one following motor vehicle, and controlling components of one or all motor vehicles according to the respective control signal data sets.

### CROSS-REFERENCE TO RELATED APPLICATION

This patent application claims priority to German Application No. DE 102021116468.0 filed on Jun. 25, 2021, which is hereby incorporated by reference in its entirety.

### BACKGROUND

The present disclosure relates to a method for the operation of a vehicle platoon having a plurality of motor vehicles.

A vehicle platoon is understood to be an association of a plurality of motor vehicles, in particular trucks, which can drive one after the other at a very short distance with the help of a technical control system. The motor vehicles may also be considered to be connected to each other by an “electronic drawbar.”

The advantages of a vehicle platoon include the reduction of the load on human drivers as well as lower fuel consumption at normal motorway speeds due to the reduced air resistance in the slipstream. The possible driving of multiple motor vehicles by only one human driver in the first motor vehicle would save hauliers not only fuel but also personnel costs. Furthermore, the efficiency of motorways can be increased by a reduced risk of traffic jams and also vehicles can be more efficiently operated.

In some implementations, only the first motor vehicle of the vehicle platoon is controlled by a human driver, while the following motor vehicles of the vehicle platoon follow without drivers. In other words, the following motor vehicles implement the movements of the first motor vehicle with a time delay.

For typical operation, a time buffer (sometimes referred to as a headway time) of 0.3 s is required. This leads, for example, at a speed of 100 km/h to a minimum distance of 8.3 m to be observed. Exceeding the minimum distance during operation can lead to the vehicle platoon being broken up, i.e., the coupling of motor vehicles with each other is lost.

The vehicle platoon can also be broken up by other motor vehicles that do not belong to the vehicle platoon entering the gap defined by the minimum distance. This could be counteracted by reducing the required minimum distance.

### SUMMARY

One or more implementations of the present disclosure are capable of reducing a minimum distance in a vehicle platoon by a method for operating the vehicle platoon that includes recording of operating data of each vehicle of the vehicle platoon, transmitting the recorded operating data of the at least one following motor vehicle of the vehicle platoon to the first motor vehicle of the vehicle platoon, evaluating the operating data in order to determine a control signal data set for driving components of each of the motor vehicles of the vehicle platoon, transmitting the respective control signal data sets to the at least one following motor vehicle, and controlling a component of one or all motor vehicles according to the respective control signal data sets.

Based on the operating data of all motor vehicles of the vehicle platoon, individual control signal data sets for each vehicle of the vehicle platoon may be determined and then the respective components of the respective motor vehicle of the vehicle platoon can be controlled. Thus, the motor vehicles of the vehicle platoon following the first motor vehicle ahead do not follow slavishly, i.e., for example by implementing steering movements and/or accelerations and/or braking maneuvers of the first motor vehicle identically, at most with a time delay, but can react individually.

Thus, operation with a reduced minimum distance between the vehicles of the vehicle platoon is possible. Other motor vehicles that do not belong to the vehicle platoon cannot enter this gap between the motor vehicles of the vehicle platoon and break this up.

According to one implementation, delaying the control signal data set for controlling a first motor vehicle of the vehicle platoon may also be done. Thus, an implementation of the control signal data set for controlling a first motor vehicle of the vehicle platoon may be delayed compared to a wireless transmission and subsequent implementation of the respective control signal data sets for the following vehicles of the vehicle platoon, for example by 20 ms to 50 ms. In this way, the signal propagation times of the respective control signal data sets of the transmission of the respective control signal data sets to the following motor vehicles of the vehicle platoon can be compensated. In other words, all components of all motor vehicles of the vehicle platoon are essentially controlled simultaneously or synchronously according to the respective control signal data sets. Simultaneously or synchronously is essentially understood to mean that it remains possible to maintain the vehicle platoon at the predetermined minimum distance.

According to a further implementation, a determination of control signal data sets for at least following motor vehicles of the vehicle platoon may additionally be carried out in order to ensure a predetermined minimum distance between two of the motor vehicles by accelerating and/or decelerating each motor vehicle. Here, the first motor vehicle of the vehicle platoon can be controlled by a human driver, while the following motor vehicles drive automatically and thus automatically follow the first motor vehicle of the vehicle platoon. Maintaining the predetermined minimum distance may include accelerating individual vehicles of the vehicle platoon while braking other motor vehicles. In other words, the control signal data sets for at least following vehicles of the vehicle platoon can be indicative of different accelerations and/or braking maneuvers for controlling the respective motor vehicles individually. It may also be provided that a greater value shall be chosen for the predetermined minimum distance between the first motor vehicle and the second motor vehicle than for the respective minimum distances between following motor vehicles. In other words, the minimum distance between the first motor vehicle and the second motor vehicle is greater than any other minimum distance between the following motor vehicles.

According to a further implementation, a determination of a control signal data set for the first motor vehicle of the vehicle platoon may be additionally carried out in order to ensure a predetermined minimum distance between each two of the motor vehicles by accelerating and/or decelerating each motor vehicle. Here, the first motor vehicle of the vehicle platoon can be driven automatically. In order to maintain the predetermined minimum distance, the first motor vehicle is now also included, i.e., it can be accelerated or decelerated like the following motor vehicles, since there is no accelerator pedal and/or brake pedal operation by a human driver.

According to a further implementation, the operating data may include brake operating data indicative of the braking behavior, and may further include evaluation of the brake operating data and adjustment of braking parameters, especially of the first motor vehicle.

An individual braking capacity of the individual motor vehicles for which braking operating data are indicative may therefore be taken into account. In this way, it can be ensured that a motor vehicle ahead of a following motor vehicle of the vehicle platoon does not brake too strongly from the perspective of the following motor vehicle.

According to a further implementation, a braking process may be recorded by evaluating the operating data, and, for a recorded braking process, the control signal data sets with brake control signals may be determined in such a way that a distance between the motor vehicles of the vehicle platoon is increased. The braking process can be a currently performed braking process or a planned braking process, which is considered necessary before a vehicle control. It can be achieved, for example, in such a way that a following motor vehicle is braked more strongly than a motor vehicle ahead. In this way, the distance between these two motor vehicles can be increased if necessary.

Furthermore, the present disclosure includes a computer program product in the form of a non-transitory computer-readable medium, a control unit to perform the method, and a motor vehicle with such a control unit.

### BRIEF DESCRIPTION OF THE DRAWINGS

FIG. 1 shows in a schematic representation a vehicle platoon with a plurality of motor vehicles.

FIG. 2 shows in a schematic representation of components of the motor vehicles of the vehicle platoon shown in FIG. 1.

FIG. 3 shows in a schematic representation a process sequence for the operation of the vehicle platoon shown in FIG. 1.

### DETAILED DESCRIPTION

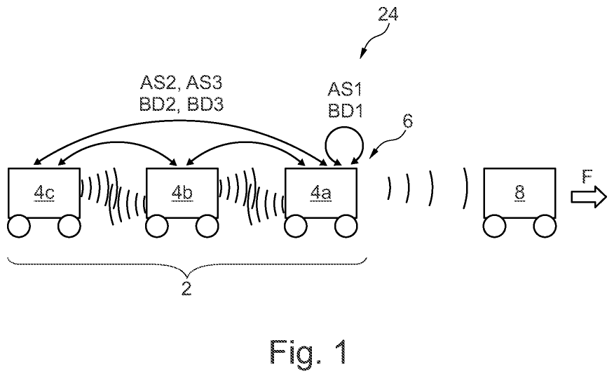

With reference to FIG. 1, a system 24 for the operation of a vehicle platoon 2 in the present example implementation is shown.

In the present example implementation, the vehicle platoon 2 comprises three motor vehicles 4a, 4b, 4c with a first motor vehicle 4a ahead in the direction of travel F and two following motor vehicles 4b, 4c.

With the help of a technical control system, the motor vehicles 4a, 4b, and 4c of the vehicle platoon 2 can drive behind each other at a very short distance. The motor vehicles 4a, 4b, and 4c can also be regarded as connected to each other with an electronic drawbar.

The motor vehicles 4a, 4b, and 4c in the present example implementation are all trucks. However, other types of motor vehicles, such as cars, can also form the vehicle platoon 2. In a difference from the present example implementation, the number of following motor vehicles 4b, 4c may also be different.

In the present example implementation, all motor vehicles 4a, 4b, and 4c of the vehicle platoon 2 are designed for bidirectional wireless data exchange, for example according to ITS-G5 (=DSRC) or C-V2X PCS.

In particular, the first motor vehicle 4a has environment sensors (not shown in FIG. 1), such as lidar, radar, ultrasonic sensor systems, and/or camera systems in order to be able to detect, for example, obstacles on its path, such as a road user 8 ahead.

The following motor vehicles 4b, 4c in the present example implementation, on the other hand, each have distance sensors (not shown) with which a distance to the respective vehicle ahead of the vehicle platoon 2 can be determined. For this purpose, the distance sensors can be designed for detecting distances of up to 10 meters. In other words, the distance sensors differ from the environment sensors by their significantly shorter range.

In order to detect a required minimum distance between the motor vehicles 4a, 4b, and 4c of the vehicle platoon 2 during a journey, a control unit 6 of the first motor vehicle 4a is designed to record and read in operating data BD1 of the first motor vehicle 4a of the vehicle platoon 2.

Furthermore, the following motor vehicles 4b, 4c are also designed to record their respective operating data BD2, BD3 and to transmit these data wirelessly to the first motor vehicle 4a, wherein the control unit 6 is also designed to read these operating data BD2, BD3. The transfer can take place directly, i.e., from the second motor vehicle 4b to the first motor vehicle 4a, or even indirectly, i.e., from the third motor vehicle 4c to the first motor vehicle 4a of the vehicle platoon 2 with the interconnection of the second motor vehicle 4b.

The control unit 6 is designed to evaluate the operating data BD1, BD2, and BD3 to determine a respective control signal data set AS1, AS2, and AS3 for controlling components of each of the motor vehicles 4a, 4b, and 4c of the vehicle platoon 2. For this purpose and for the tasks and functions described below, the control unit 6 may have hardware and/or software components.

While the control signal data set AS1 for the components of the first motor vehicle 4a is transmitted to its components internally, for example via a CAN bus of the first motor vehicle 4a, the respective control signal data sets AS2, AS3 for controlling the components of the following motor vehicles 4b, 4c are transmitted to the following motor vehicles 4b, 4c wirelessly. This can be done directly, i.e., from the first motor vehicle 4a to the second motor vehicle 4b, or indirectly, i.e., from the first motor vehicle 4a to the third motor vehicle 4c of the vehicle platoon 2 with the interconnection of the second motor vehicle 4b.

On reception of the respective control signal data sets AS1, AS2, and AS3, the respective components of the motor vehicles 4a, 4b, and 4c are then controlled in a coordinated manner in order to maintain the required minimum distance between the respective motor vehicles 4a, 4b, and 4c of the vehicle platoon 2 during a journey.

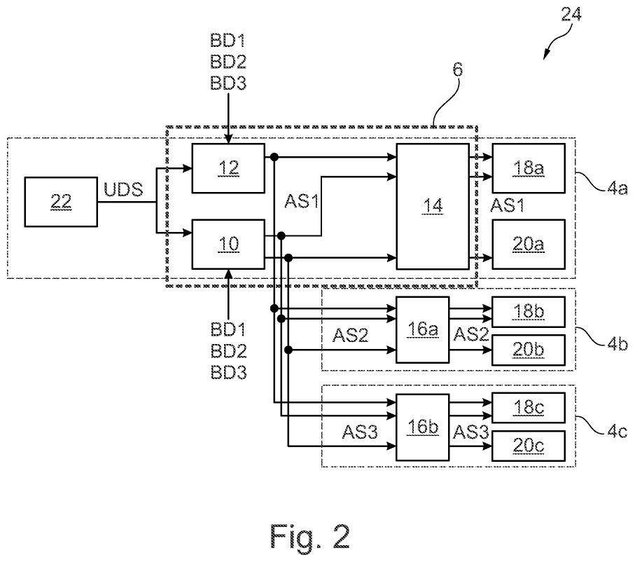

With reference to FIG. 2, components of the control unit 6 as well as other components of the first motor vehicle 4a, with which the control unit 6 interacts, are shown. Furthermore, components of the following motor vehicles 4b, 4c are shown which also interact with the control unit 6 of the first motor vehicle 4a.

One of the components of the control unit 6 shown is an adaptive cruise control module 10 for cruise control, which includes the distance to the road user 8 ahead, for example, as an additional feedback and controlled variable.

Another component of the control unit 6 shown is an emergency braking system module 12, which alerts a human driver about a braking situation, supports emergency braking (brake assist) or brakes automatically.

Another component of the control unit 6 shown is a delay module 14, which is designed to delay the control signal data set AS1 for controlling the components of the first motor vehicle 4a.

Of the components of the first motor vehicle 4a, a brake actuator 18a, an acceleration actuator 20a, and an environment sensor 22 are also shown in FIG. 2.

Of the components of the following motor vehicles 4b, 4c, respective receiver modules 16a, 16b for receiving the control signal data sets AD2, AD3, respective brake actuators 18b, 18c, and respective acceleration actuators 20b, 20c are shown.

During operation, the environment sensor 22 determines a distance from the first motor vehicle 4a to the road user 8 and makes this available as part of an environment data set UDS to the adaptive cruise control module 10 and the emergency braking system module 12 as part of the operating data BD1. Furthermore, the operating data BD1 may also contain data indicative, for example, of the speed of the first motor vehicle 4a and/or its acceleration or deceleration. Furthermore, the operating data BD1 may also contain data indicative of a distance to the first following motor vehicle 4b.

Analogously, the operating data BD2, BD3 of the following motor vehicles 4b, 4c may contain data for their respective speeds and/or accelerations or decelerations, for example. Furthermore, the operating data BD2, BD3 may also contain data indicative of a distance to the two following motor vehicles 4b, 4c, for example.

According to the recorded traffic situation, in the present example implementation the adaptive cruise control module 10 or the emergency braking system module 12 determines the control signal data sets AS1, AS2, and AS3.

The control signal data sets AS2, AS3 are transmitted to the following motor vehicles 4b, 4c, received there by the respective receiver modules 16a, 16b and then cause control of the respective components, i.e., the respective brake actuators 18b, 18c and/or acceleration actuators 20b, 20c.

In order to take into account the transition time of the control signal data sets AS2, AS3 to the following motor vehicles 4b, 4c, in the present example implementation the delay module 14 causes a time delay of the control signal data set AS1, in the present example implementation by a time duration of 20 ms to 50 ms. Thus, it is achieved that all components of all motor vehicles 4a, 4b, and 4c of the vehicle platoon 2 are essentially controlled simultaneously or synchronously according to the respective control signal data sets AS1, AS2, and AS3, and thus all motor vehicles 4a, 4b, and 4c of the vehicle platoon 2 accelerate or decelerate uniformly.

In the present example implementation, the adaptive cruise control module 10 is designed to increase a value for a predetermined time buffer (i.e., headway time) or minimum distance to take into account the delay by the delay module 14. In the present example implementation, the time buffer is increased by the time duration caused by the delay module 14, in the present example implementation 20 ms to 50 ms.

Furthermore, in the present example implementation, the emergency braking system module 12 is designed to increase a time horizon of usually 150 ms to 400 ms in a manner analogous to the adaptive cruise control module 10 to take into account the time duration caused by the delay module 14. In the present example implementation, the time duration is again in the range of 20 ms to 50 ms.

Furthermore, it is provided in the present example implementation that the control signal data sets AS1, AS2, and AS3 for the motor vehicles 4a, 4b, and 4c of the vehicle platoon 2 are determined in such a way that the predetermined minimum distance between each two of the motor vehicles 4a, 4b, and 4c is ensured by accelerating and/or decelerating each motor vehicle 4a, 4b, and 4c.

For this purpose, in the present example implementation the first motor vehicle 4a is designed for autonomous driving at least according to SAE level 2.

In other words, all motor vehicles 4a, 4b, and 4c are now responsible for complying with the predetermined minimum distance. The resulting accelerations due to the fault dynamics are distributed to the motor vehicles 4a, 4b, and 4c, so that the following applies for the respective desired accelerations a₁, a₂, and a₃ of the respective motor vehicles 4a, 4b, and 4c:

a₁=f₁(e_{2,1}, e_{3,2}, u₁, u₂, u₃)

a₂=f₂(e_{2,1}, e_{3,2}, u₁, u₂, u₃)

a₃=f₃(e_{2,1}, e_{3,2}, u₁, u₂, u₃)

The index 1, 2, and 3 refers to the position of the respective motor vehicle 4a, 4b, and 4c in the vehicle platoon 2, refers to a respective control difference between a respective target value and actual value of a distance between the respective motor vehicles 4a, 4b, and 4c, uᵢ refers to the respective controlled variable and fᵢ refers to a control algorithm, such as a PID (proportional-integral-derivative) controller.

It may be provided that the respective control signal data sets AS1, AS2, and AS3 lead to the following reactions summarized in the following Table 1.

TABLE 1

| | first motor | second motor | third motor |
|---|---|---|---|
| | vehicle 4a | vehicle 4b | vehicle 4c |
| Distance between | Acceleration | Deceleration | Deceleration |
| the first motor | | | |
| vehicle 4a and the | | | |
| second motor | | | |
| vehicle 4b | | | |
| decreases or is too | | | |
| small | | | |
| Distance between | Acceleration | Acceleration | Deceleration |
| the second motor | | | |
| vehicle 4b and the | | | |
| third motor | | | |
| vehicle 4c | | | |
| decreases or is too | | | |
| small | | | |
| Distance between | Deceleration | Acceleration | Acceleration |
| the first motor | | | |
| vehicle 4a and the | | | |
| second motor | | | |
| vehicle 4b | | | |
| increases or is too | | | |
| large | | | |
| Distance between | Deceleration | Deceleration | Acceleration |
| the second motor | | | |
| vehicle 4b and the | | | |
| third motor | | | |
| vehicle 4c | | | |
| increases or is too | | | |
| large | | | |

If, on the other hand, a human driver controls the first motor vehicle 4a, only the control signal data sets AS2, AS3 for the following motor vehicles 4b, 4c of the vehicle platoon 2 are determined, since the human driver specifies an acceleration or deceleration of the first motor vehicle 4a by pressing the accelerator and brake pedals.

For the respective desired accelerations a₂, a₃ of the respective following motor vehicles 4b, 4c, the following then applies:

a₂=f₂(e_{2,1}, e_{3,2}, u₁, u₂, u₃)

a₃=f₃(e_{2,1}, e_{3,2}, u₁, u₂, u₃)

It may be provided that the respective control signal data sets AS2, AS3 lead to the following reactions summarized in the following Table 2.

TABLE 2

| | first motor | second motor | third motor |
|---|---|---|---|
| | vehicle 4a | vehicle 4b | vehicle 4c |
| Distance between | No signal | Deceleration | Deceleration |
| the first motor | | | |
| vehicle 4a and the | | | |
| second motor | | | |
| vehicle 4b | | | |
| decreases or is too | | | |
| small | | | |
| Distance between | No signal | Acceleration | Deceleration |
| the second motor | | | |
| vehicle 4b and the | | | |
| third motor | | | |
| vehicle 4c | | | |
| decreases or is too | | | |
| small | | | |
| Distance between | No signal | Acceleration | Acceleration |
| the first motor | | | |
| vehicle 4a and the | | | |
| second motor | | | |
| vehicle 4b | | | |
| increases or is too | | | |
| large | | | |
| Distance between | No signal | Deceleration | Acceleration |
| the second motor | | | |
| vehicle 4b and the | | | |
| third motor | | | |
| vehicle 4c | | | |
| increases or is too | | | |
| large | | | |

Furthermore, it may be provided that when a human driver drives the first motor vehicle 4a, a modified parameter data set is used, which for example specifies an increased distance between the first motor vehicle 4a and the second motor vehicle 4b.

Furthermore, it is provided in the present example implementation that the operating data may contain brake operating data indicative of the braking behavior. The braking operating data indicative of the braking behavior can, for example, describe a dynamic response deceleration of the braking system of the respective motor vehicle 4a, 4b, and 4c. The response deceleration can be detected with a pressure sensor to measure the brake pressure build-up. Furthermore, braking operating data indicative of the braking behavior may contain control signals of an ABS/ESP system of the respective motor vehicle 4a, 4b, and 4c.

During operation, the brake operating data are evaluated and the braking parameters, in particular of the first motor vehicle 4a, are adjusted.

For this purpose, it may be provided that the braking parameters are modified in such a way that a maximum deceleration due to braking of the motor vehicle 4a, 4b, and 4c with the weakest brake is not exceeded.

On the other hand, based on the road user ahead 8, such an intervention to limit the braking force may be omitted.

If the first motor vehicle 4a is the motor vehicle with the lowest maximum deceleration, then based on the road user ahead 8, the braking performance of the following motor vehicles 4b, 4c may not be limited.

Furthermore, it is provided in the present example implementation that on the detection of a braking process, brake control signals are determined in such a way that a distance between the motor vehicles 4a, 4b, 4c of the vehicle platoon 2 is increased.

For example, it may be provided that the predetermined minimum distance between the motor vehicles 4a, 4b, and 4c is increased if:
the first motor vehicle 4a brakes,
the first motor vehicle 4a brakes more strongly than the following motor vehicles 4b, 4c,
the first motor vehicle 4a will brake within a time horizon, and/or
the first motor vehicle 4a brakes more strongly than the following motor vehicles 4b, 4c within a time horizon.

In other words, the following motor vehicles 4b, 4c must brake more strongly than the respective vehicles ahead 4b, 4c.

For this purpose, for example, the control unit 6 in the present example implementation determines a value for a probability of braking and communicates this to the other motor vehicles 4b, 4c. The control unit 6 of the first motor vehicle 4a determines the required braking intervention for all motor vehicles 4a, 4b, and 4c and communicates this to the other following motor vehicles 4b, 4c.

As a result, the braking system of the first motor vehicle 4a has a normal or unchanged intervention threshold for braking intervention. On the other hand, the second motor vehicle 4b has a lowered intervention threshold which is lower than the intervention threshold of the first motor vehicle 4a. The lowered intervention threshold means that the second motor vehicle 4b is braked or decelerated before the first motor vehicle 4b.

In an analogous manner, the intervention threshold of the third motor vehicle 4c is lowered again. This means that the intervention threshold of the third motor vehicle 4c is lower than the intervention threshold of the second motor vehicle 4b. The lowered intervention threshold causes the third motor vehicle 4c to be braked or decelerated before the second motor vehicle 4b.

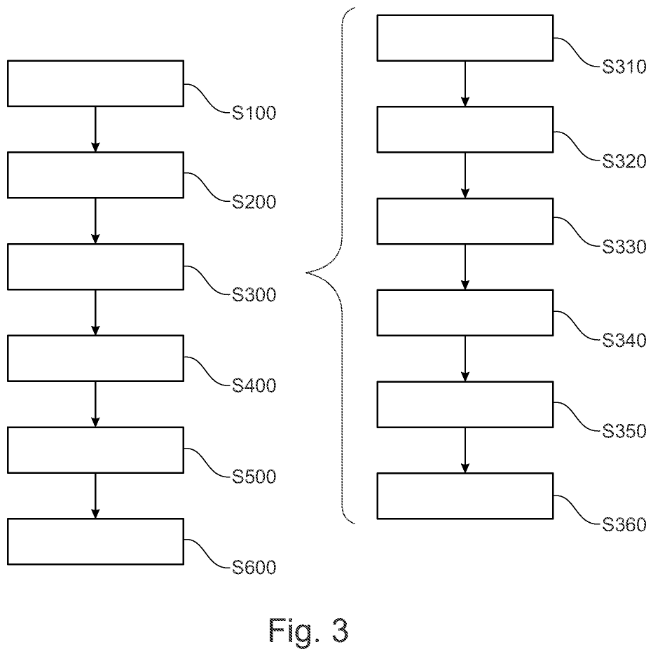

With additional reference to FIG. 3, a procedure for the operation of the system 24 is now explained.

In a first step S100, the operating data BD1, BD2, and BD3 of each motor vehicle 4a, 4b, and 4c of the vehicle platoon 2 are recorded.

In a further step S200, the recorded operating data BD1, BD2, and BD3 of at least one following motor vehicle 4b, 4c of the vehicle platoon 2 are transmitted to the first motor vehicle 4a of the vehicle platoon 2.

In a further step S300, the operating data BD1, BD2, and BD3 are evaluated to determine the respective control signal data sets AS1, AS2, and AS3 for controlling the component of each of the motor vehicles 4a, 4b, and 4c of the vehicle platoon 2.

In a sub-step S310 of step S300, the control signal data sets AS2, AS3 for at least the following motor vehicles 4b, 4c of the vehicle platoon 2 are determined to ensure a predetermined minimum distance between each two of the motor vehicles 4a, 4b, and 4c by accelerating and/or decelerating each motor vehicle 4a, 4b, and 4c.

In a further sub-step S320 of step S300, the control signal data set AS1 for the first motor vehicle 4a of the vehicle platoon 2 is additionally determined in order to ensure a predetermined minimum distance between each two of the motor vehicles 4a, 4b, and 4c by accelerating and/or decelerating each motor vehicle 4a, 4b, and 4c.

If the operating data BD1, BD2, and BD3 contain braking operating data indicative of the braking behavior, the brake operating data are evaluated in a further sub-step S330 of step S300 and the braking parameters, in particular of the first motor vehicle 4a, are adjusted in a further sub-step S340.

In a further sub-step S350 of step S300, a braking process is recorded by evaluating the operating data BD1, BD2, and BD3, and in a further sub-step 5360, the control signal data sets AS1, AS2, and AS3 with brake control signals are determined in such a way that a distance between the motor vehicles 4a, 4b, and 4c of the vehicle platoon 2 is increased.

In a further step S400, the respective control signal data sets AS2, AS3 are transmitted to the at least one following motor vehicle 4b, 4c.

In a further step S500 there is a delay of the control signal data set AS1 for the control of components of the first motor vehicle 4a of the vehicle platoon 2.

In a further step S600, at least one component of one of the motor vehicles 4a, 4b, and 4c is controlled according to the respective control signal data set AS1, AS2, and AS3.

In implementations different from the present example implementation, the order of the steps or sub-steps may also be different. Furthermore, several steps or sub-steps can also be carried out at the same time or simultaneously. Furthermore, individual steps or sub-steps can also be omitted or skipped.

Thus, operation with a reduced minimum distance between the motor vehicles 4a, 4b, and 4c of the vehicle platoon 2 is possible. This gap between the motor vehicles 4a, 4b, and 4c of the vehicle platoon 2 can no longer be entered by other motor vehicles that do not belong to vehicle platoon 2 and, thus, cannot break it up.

### REFERENCE CHARACTER LIST

2 Vehicle platoon
4a Motor vehicle
4b Motor vehicle
4c Motor vehicle
6 Control unit
8 Road user
10 Cruise Control module
12 Emergency braking system module
14 Delay module
16a Receiver module
16b Receiver module
18a Brake actuator
18b Brake actuator
18c Brake actuator
20a Acceleration actuator
20b Acceleration actuator
20c Acceleration actuator
22 Environment sensor
24 System
a₁ Acceleration
a₂ Acceleration
a₃ Acceleration
AS1 Control signal record
AS2 Control signal record
AS3 Control signal record
BD1 Operational data
BD2 Operational data
BD3 Operational data
e_{i,j} Control difference
F Direction of travel
fᵢ Control algorithm
UDS Environment Record
S100 Step
S200 Step
S300 Step
S310 Sub-step
S320 Sub-step
S330 Sub-step
S340 Sub-step
S350 Sub-step
S360 Sub-step
S400 Step
S500 Step
S600 Step

1.-15. (canceled)

16. A method for operating a vehicle platoon having a plurality of motor vehicles, comprising:
recording operating data of each motor vehicle of the vehicle platoon;
transmitting the recorded operating data of at least one following motor vehicle of the vehicle platoon to a first motor vehicle of the vehicle platoon;
evaluating the operating data to determine a control signal data set for controlling components of each of the motor vehicles of the vehicle platoon;
transmitting the respective control signal data sets to the at least one following motor vehicle; and
controlling the components of one or all motor vehicles according to the respective control signal sets.

17. The method according to claim 16, further comprising:
delaying the control signal data set for controlling a first motor vehicle of the vehicle platoon.

18. The method according to claim 16, wherein the determination of control signal data sets for at least following motor vehicles of the vehicle platoon provides for a predetermined minimum distance between each two of the motor vehicles by accelerating and/or decelerating each motor vehicle.

19. Method according to claim 18, wherein the determination of a control signal record for the first motor vehicle of the vehicle platoon provides for a predetermined minimum distance between two of the motor vehicles by accelerating and/or decelerating each motor vehicle.

20. Method according to claim 16, wherein the operating data contain braking operating data indicative of braking behavior, wherein evaluating the operating data includes:
evaluating the braking operating data; and
adjusting braking parameters of the first motor vehicle.

21. Method according to claim 16, further comprising:
recording of a braking process by evaluating the operating data; and
in response to a recorded braking operation, determining control signal data sets with brake control signals configured to increase a distance between the motor vehicles of the vehicle platoon.

22. A control unit of a lead vehicle to operate a vehicle platoon having a plurality of motor vehicles, the control unit comprising a processor and a memory, the memory storing instructions executable by the processor, the instructions including instructions to:
record operating data of the lead vehicle;
receive recorded operating data of at least one following motor vehicle of the vehicle platoon;
evaluate the operating data of the plurality of vehicles to determine a control signal data set for controlling components of each of the motor vehicles of the vehicle platoon; and
transmit the respective control signal data sets to the at least one following motor vehicle,
wherein the components of one or all motor vehicles of the vehicle platoon are controlled according to the respective control signal sets.

23. The control unit of claim 22, further comprising instructions to cause a time delay of the control signal data set for controlling the lead vehicle of the vehicle platoon.

24. The control unit of claim 22, further comprising instructions to provide control signal data sets for at least following motor vehicles of the vehicle platoon to ensure a predetermined minimum distance between each two of the motor vehicles by accelerating and/or decelerating each motor vehicle.

25. The control unit of claim 22, further comprising instructions to determine a control signal data set for the first motor vehicle of the vehicle platoon in order to ensure a predetermined minimum distance between each two of the motor vehicles by accelerating and/or decelerating each motor vehicle.

26. The control unit of claim 22, wherein the operating data contain braking operating data indicative of braking behavior, and further comprising instructions to evaluate the braking operating data and to adjust braking parameters of the lead vehicle.

27. The control unit of claim 22, further comprising instructions to detect a braking process to determine brake control signals in such a way that a distance between the motor vehicles of the vehicle platoon is increased.

28. The lead vehicle comprising the control unit of claim 22.

29. A non-transitory computer-readable medium having stored thereon computer-executable instructions configured to cause a processor of a lead vehicle to operate a vehicle platoon having a plurality of motor vehicles, the instructions including instructions to:
record operating data of the lead vehicle;
receive recorded operating data of at least one following motor vehicle of the vehicle platoon;
evaluate the operating data of the plurality of vehicles to determine a control signal data set for controlling components of each of the motor vehicles of the vehicle platoon; and
transmit the respective control signal data sets to the at least one following motor vehicle,
wherein the components of one or all motor vehicles of the vehicle platoon are controlled according to the respective control signal sets.

30. The non-transitory computer-readable medium of claim 29, further comprising instructions to cause a time delay of the control signal data set for controlling the lead vehicle of the vehicle platoon.

31. The non-transitory computer-readable medium of claim 29, further comprising instructions to provide control signal data sets for at least following motor vehicles of the vehicle platoon to ensure a predetermined minimum distance between each two of the motor vehicles by accelerating and/or decelerating each motor vehicle.

32. The non-transitory computer-readable medium of claim 29, further comprising instructions to determine a control signal data set for the lead vehicle of the vehicle platoon in order to ensure a predetermined minimum distance between each two of the motor vehicles by accelerating and/or decelerating each motor vehicle.

33. The non-transitory computer-readable medium of claim 29, wherein the operating data contain braking operating data indicative of braking behavior, and further comprising instructions to evaluate the braking operating data and to adjust braking parameters of the lead vehicle.

34. The non-transitory computer-readable medium of claim 29, further comprising instructions to detect a braking process to determine brake control signals in such a way that a distance between the motor vehicles of the vehicle platoon is increased.
